(19) United States
(12) Patent Application Publication
(10) Pub. No.: US 2019/0077625 A1
(43) Pub. Date: Mar. 14, 2019

(54) Adhesive Resistant Coating for Web Handling Devices

(71) Applicant: Maxcess International, Oklahoma City, OK (US)

(72) Inventors: Pete Ackerman, Vancouver, WA (US); Eric Koppes, Camas, WA (US)

(21) Appl. No.: 15/705,234

(22) Filed: Sep. 14, 2017

(51) Int. Cl. B65H 23/04; B65H 27/00; B26D 1/12

(52) U.S. Cl. CPC B65H 23/048; B26D 2001/0066; B26D 1/125; B65H 27/00

(57) ABSTRACT

The invention pertains to coating web handling devices with a hydrophobic and oleophobic coating for preventing the accumulation of adhesive and inks from the web. The web being a web with a layer of adhesive or ink.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The invention relates to the web manufacturing industry. Materials like paper, films and various laminates are typically manufactured as a continuous sheet or web of material. During the processing of a continuous web, the web is handled by cylindrical rolls and cut into continuous strips. Many of these webs include an adhesive layer or even multiple layers. These layered webs are typical of printing operations for manufacturing labels, tapes and other packaging material. Additionally, these webs can be relatively wide making access during maintenance very difficult.

The instant invention is the use of a hydrophobic and oleophobic coating for preventing adhesive from becoming stuck to the web handling devices, such as rollers for guiding the web and slitter and anvil devices which cut the web into strips.

The prior art cited in FIG. 1 addresses resisting the buildup of adhesive by applying a thin oil layer onto a shear slitting blade. This layer of oil prevents the adhesive from adhering to the shear slitting blade and anvil during the slitting operation. The slitting operation provides for cutting a web of material along its length in a scissor type action. Referring again to FIG. 1, the web 100 is moved through a slitting area 101. The slitting area 101 includes a shear slitting blade 102 and cylindrical anvil 103. The shear slitting blade 102 is pushed against the side of the anvil 103 creating an overlap 106 of the anvil 101 and the shear slitter blade 102. This overlapping causes the web 100 to be cut or slit along the direction of movement 104.

A web 100 containing adhesive 100A on either side will tend to accumulate adhesive on the anvil 103 and the shear slitter blade 102. This accumulation can build up and cause the shear slitter blade 102 and anvil 103 to separate, in turn this causes the slitting operation to be ineffective.

Additionally, adhesive can accumulate on rollers which are used to handle the web during processing. For instance, referring to FIG. 2, the web 100 is shown traveling in direction 203 as the roller 201 spins about its' axis in direction 205. Since the roller 201 is of constant radius 206, the velocity of the web 100 around the roller 201 is constant. However, if the roller 201 radius 206 varies the velocity of the web 100 and or the roller 201 will change.

Referring now to FIG. 3, an accumulation of adhesive 301 is shown between the web 100 and the roller 201. As a result, the web 100 is lifted to a radius 306 and the rest of the web 100 is still at the radius 206 of the roller. This geometry requires that the web 1000 move at a slightly faster speed in the area where the web 100 is lifted to radius 301. This causes non-uniform tension in the web 100 and can cause localized stretching that contributes to defective web 100.

It has been found that applying a small amount of oil to the web handling devices can reduce the accumulation of adhesive. FIG. 1 shows a device that applies oil to the shear slitter blade. In this case a fibrous material 105 is placed into a holder 107 and the fibrous material 105 is soaked with oil. The fibrous material 105 is also in contact with the shear slitter blade 102 and so as the shear slitter blade 102 rotates and cuts the web 100 the oil is applied to the shear slitter blade 102 through direct contact with the fibrous material 100.

One of the draw backs to the apparatus is that the fibrous material 105 can become worn and lose contact with the shear slitter blade 102. This in turn causes the oil to stop flowing onto the shear slitter blade 102. Without the oil layer, adhesive will continue to accumulate onto the shear slitter blade 102.

Another problem with the application of an oil layer is that the oil gets on web 100. In many cases the web will accumulate the oil. This can destroy the web 100 as well as make it unusable in many downstream processes.

Occasionally, the fibrous material 105 can run low on oil, and a means of providing additional oil can be dangerous and time consuming. This is because the web 100 can be very wide requiring that the web 100 be stopped so that maintenance personnel can replenish the fibrous material 105 with oil.

Additionally, the use of the invention eliminates the need for an oil film and prevents the oil contamination of the web 100. The use of an oil can be prohibitive in certain industries. It has been found that parts coated with a hydrophobic and oleophobic coating does not contaminate the web.

### BRIEF SUMMARY OF THE INVENTION

In view of the previously mentioned prior art a method of reducing or eliminating the accumulation of adhesive to web handling rollers and slitter blades has been discovered. The method includes coating the rollers and blades with a hydrophobic and oleophobic coating. It has been found that these types of coatings work very well to prevent pressure sensitive adhesive from building up on these web handling and slitting devices.

This method eliminates the need of applying oil or other lubricant directly to the rollers and slitter blades. Thus, eliminating contamination of the web as well as eliminating the maintenance time for replenishing oil.

### BRIEF DESCRIPTION OF THE DRAWINGS

FIG. 1: Side of a Shear Slitter with the Prior Art.

FIG. 2: Side View of a Roller without adhesive debris.

FIG. 3: Side View of a Roller with adhesive debris.

FIG. 4: Side View of a Shear Slitter and Anvil as a web is cut.

FIG. 5: Enlarged Cross Section of a Front View of the Shear Slitter and Anvil as a web is cut.

FIG. 6: Front View of a Shear Slitter and Anvil as a web is cut.

FIG. 7: Broken Top View of a Guide Roller (also referred to as an idler) guiding a web.

FIG. 8: Side View of a Guide Roller (also referred to as an idler) guiding a web.

FIG. 9: Front View of a Crush Slitter crushing or scribing a web.

FIG. 10: Enlarged Front View of a Crush Slitter crushing or scribing a web.

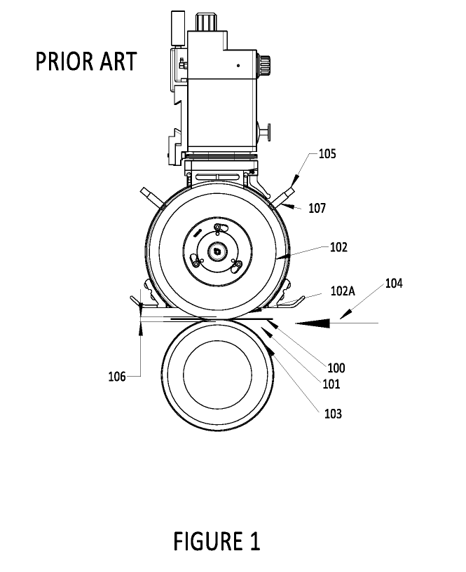

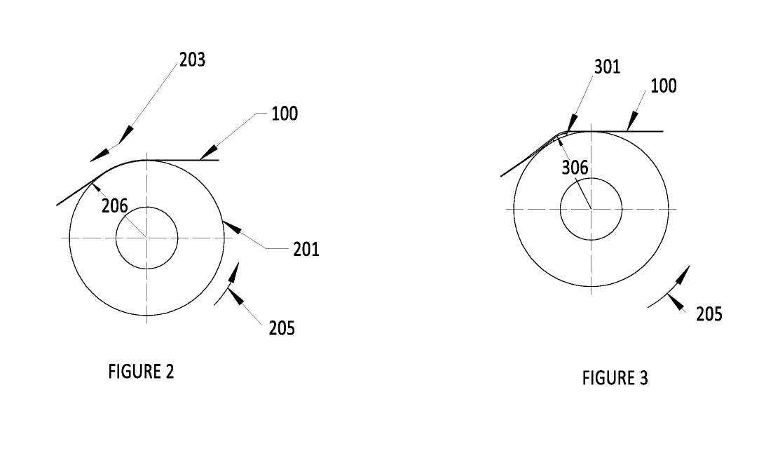

### DETAILED DESCRIPTION OF PREFERRED EMBODIMENT

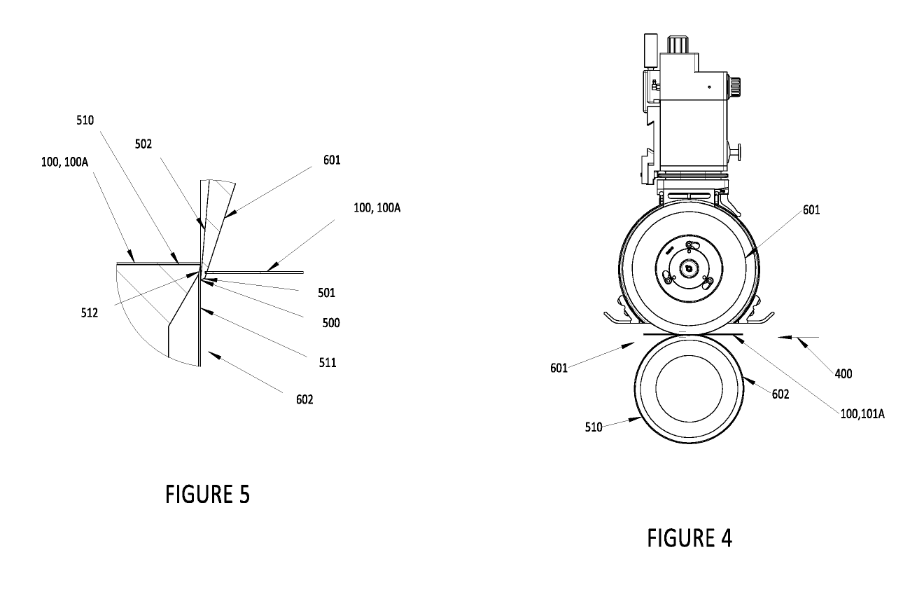

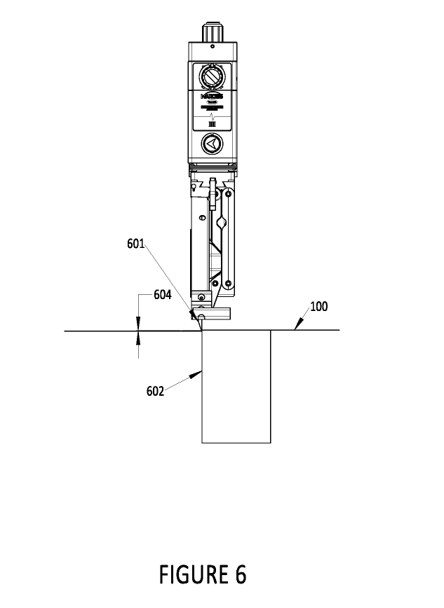

A first implementation is a shear slitter configuration. Referring to FIG. 6, the shear slitter blade 601 is held against the side of the anvil 602. Both the anvil 602 and the shear slitter blade 601 have a hydrophobic and oleophobic coating applied on their respective surfaces. The shear slitter blade 601 and the anvil 602 overlap in the slitting area 604. As the shear slitter blade 601 and the anvil 602 are rotated the causes a scissor action which cuts the web 100. This FIG. 4 shows a web 100 that is moving along a direction indicated by arrow 400 through the slitting area 604. The overlap 604 creates a scissor action that cuts the web 100 moving in the direction indicated by arrow 400.

On the web 100 is a layer of adhesive 101A, during the slitting process the adhesive 101A is pushed into contact with the shear slitter blade 601 and anvil 602. The coating applied to both the shear slitter blade 601 and the anvil 602 prevents the adhesive 100A from attaching to the shear slitter blade 601 or the anvil 602.

Referring to the FIG. 5 the web contact area on the shear slitting blade 601 is the cutting edge 500. However, the active area of the slitter blade 601 is to include the cutting edge 500, the kerf area 501 and the relief area 502.

Referring to FIG. 5 the web contact area on the anvil 602 is the outer diameter 510. However, the active area of the anvil 602 is to include the cutting edge 511, the outside diameter 510 and the relief area 512.

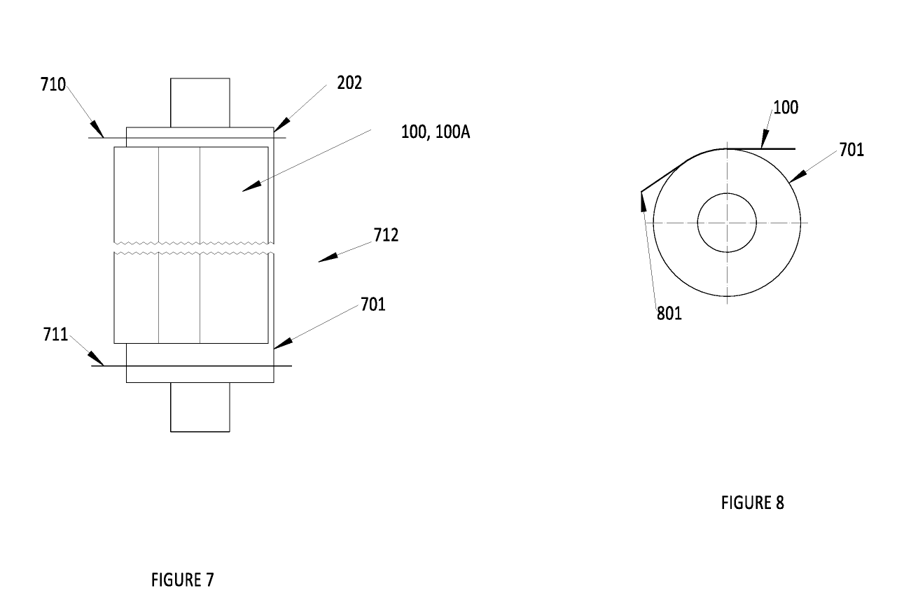

In another implementation, the coating described above should be located in the area where the adhesive debris will typically accumulate on an idler roller. As can be seen in FIG. 7 the web 100 is in contact with the roller 701 along the length of the outside diameter of the roller 701, shown on both FIGS. 7 and 8. This area of contact will be referred to as the active area 712 and spans from indicating lines 710 and 711 on the outside diameter of the idler roller 701. In this implementation, the web 100 may include layers adhesive 100A. Again, with a hydrophobic and oleophobic coating, the adhesive will be prevented from accumulating on the idler roller 701.

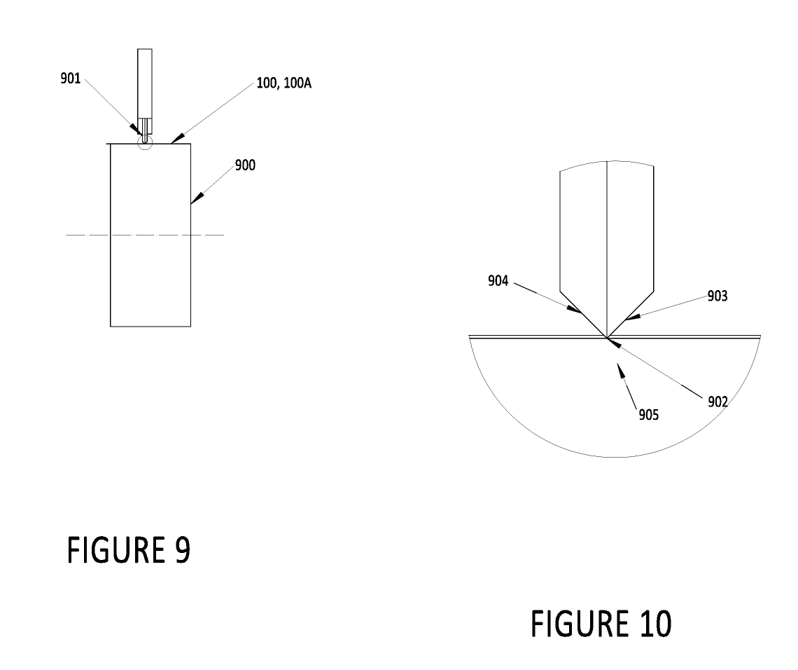

In some instances, the web 100 is cut or scribed using a “crush” or “scribing” configuration. Both of these instances use the same apparatus, the difference being that the “crush” configuration causes the web 100 to be cut while the scribe configuration deforms the web 100. FIG. 9 shows such a configuration. In this case the web 100 is moved between a cylindrical anvil 900 and a crush blade 901. Again, adhesive 100A on the web 100 will accumulate onto the crush blade 901 and anvil 900. Refer to FIG. 10, by coating the crush blade outside edge 902, and side surfaces 903 and 904, the adhesive 100A will not accumulate on the crush blade 901. Likewise coating the outside diameter of the anvil 900, adhesive will not accumulate on the anvil 900. The active area 905 of the crush blade is the crush blade outside edge 902, and the side surfaces 903 and 904.

The invention has been tested with a coating called Aculon Metal Repellent Treatment currently manufactured by Aculon located in San Diego, Calif. It has been found that this coating prevents the accumulation of adhesive on slitter and web guiding devices.

Aculon the manufacturer provides this product and considers the ingredients to be proprietary. However, included in the appendix is a brochure that explains the method of application.

The inventor submits the above embodiment of the invention with the expressed understanding that this embodiment is simple one possible way of applying the invention and is not to be used to limit the claims.

We claim:

1: A method of preventing the accumulation of adhesive on a web handling device having an active area comprising;
i) coating the active area of the web handling device with a material that is hydrophobic and oleophobic and,
ii) using the device for web handling.

2: The method of claim 1 wherein the web handling device is a slitter blade.

3: The method of claim 1 wherein the web handling device is an anvil.

4: The method of claim 1 wherein the web handling device is an idler roller.

5: A slitter blade comprising; an active area, a coating made of a material that is hydrophobic and oleophobic.

6: The slitter blade of claim 5 wherein the slitter blade is a shear slitting blade having an active area further comprising a cutting edge, a kerf area and the relief area.

7: The slitter blade of claim 5 wherein the slitter blade is a crush slitting blade having an active area further comprising an outside edge and two side surfaces.

8: A web handling device having an active area for preventing the accumulation of debris comprising a coating of hydrophobic and oleophobic material on said active area.

9: The web handling device of claim 8 wherein the device is an idler roller having an active area further comprising an outside diameter.

10: The web handling device of claim 8 wherein the device is an anvil having an active area further comprising a cutting edge, an outside diameter and a relief area.
